(19) United States
(12) Patent Application Publication
(10) Pub. No.: US 2018/0109989 A1
(43) Pub. Date: Apr. 19, 2018

(54) VOLTAGE COMPENSATION CIRCUIT, WIRELESS COMMUNICATION DEVICE, AND VOLTAGE COMPENSATION METHOD

(71) Applicant: FUJITSU LIMITED, Kawasaki-shi (JP)

(72) Inventors: Hiromi MIYAMOTO, Miura (JP); Akihiro Yamamoto, Kawasaki (JP); Shigeru NISHIKAWA, Yokohama (JP); JUNJI TAMAKI, Yokohama (JP)

(73) Assignee: FUJITSU LIMITED, Kawasaki-shi (JP)

(21) Appl. No.: 15/688,108

(22) Filed: Aug. 28, 2017

(30) Foreign Application Priority Data
Oct. 14, 2016 (JP) 2016-203021

(51) Int. Cl. H04W 40/10

(52) U.S. Cl. CPC H04W 40/10

(57) ABSTRACT

A voltage compensation circuit in a wireless communication device that performs wireless communication under a time division duplex (TDD) scheme includes a first path on which a diode is placed, a second path on which another diode is placed, and a timing controller. The first path is a path that supplies, to a transmitter-receiver, power output from a power supply and having a first voltage. The second path is a path that supplies power having a second voltage obtained by boosting the first voltage of the power output from the power supply. The timing controller switches between the first path and the second path based on information on timing of switch from signal reception to signal transmission.

### CROSS-REFERENCE TO RELATED APPLICATION

This application is based upon and claims the benefit of priority of the prior Japanese Patent Application No. 2016-203021, filed on Oct. 14, 2016, the entire contents of which are incorporated herein by reference.

### FIELD

The embodiments discussed herein are related to a voltage compensation circuit, a wireless communication device, and a voltage compensation method.

### BACKGROUND

In recent years, a time division duplex (TDD) scheme under which the same frequency is transmitted and received in a time-divided manner in the uplink and the downlink has been increasingly introduced into base station devices for wireless communication. Under the TDD scheme, periods during which a base station device receives a signal and periods during which it transmits a signal come alternately.

When transmitting a signal, the base station device transmits the signal to a terminal device after amplifying the signal using a power amplifier. In contrast, when receiving a signal transmitted from a terminal device, a base station device does not amplify a signal using a power amplifier. Consequently, a base station device consumes less power when receiving a signal than when transmitting a signal.

The base station device consumes different amounts of power when transmitting a signal and when receiving a signal. Therefore, when switching between transmission and reception, the base station device changes load currents to be supplied to a TDD transmitter-receiver that performs communication. Specifically, a base station device feeds a larger load current when transmitting a signal than when receiving a signal. The operation of the base station device at the time of switching from reception to transmission is explained here.

In the base station device, the load current sharply and rapidly increases at the time of switching from signal reception to signal transmission. When the increase of the load current is fast, the power supply fails to respond thereto by voltage control without delay, and the load current is compensated with a current discharged from a power supply capacitor connected in parallel to a load. In this case, the power supply voltage decreases in proportion to the amount of electric charge discharged from the power supply capacitor.

Thereafter, the power supply starts the response and a current output from the power supply increases. The power supply then outputs a current that is the sum of the load current to be supplied to the TDD transmitter-receiver and a charging current for charging the power supply capacitor. Thereafter, upon completion of charging the power supply capacitor, the power supply supplies, to the TDD transmitter-receiver, a load current corresponding to the amount of power to be consumed during the transmission. Here, if the sum of the load current and the charging current does not exceed an overcurrent limit value for the power supply, the power-supply voltage increases at a speed depending on the response of the power supply, and recovers to a voltage held before the decrease. In contrast, if the sum of the load current and the charging current exceeds an overcurrent limit value for the power supply, the power supply is regulated by overcurrent limitation, whereby the charging current for the power supply capacitor is limited. Consequently, it takes a certain amount of time for the power supply voltage to increase and recover to a voltage held before the decrease. In the worst case, an overcurrent is detected, and the power supply consequently stops.

As a technique for current control, there is a conventional technique configured to, if a load current exceeds an overcurrent limit value, lower a voltage control signal level in accordance with an excess of the current from a current limitation reference value to continue power supply to a load. There is another conventional technique configured to prevent the occurrence of overshoots and undershoots by detecting a rise in the power supply voltage, temporarily increasing a voltage output from a bias circuit, and temporarily increasing the operational speed of an error amplifier circuit.

One of the conventional techniques is disclosed in Japanese Laid-open Patent Publication No. 2006-31672.

However, when the power supply voltage has dropped as a result of the sharp and rapid increase in the power supply current at the start of signal transmission, the adjacent channel leakage ratio (ACLR) in signal transmission is possibly deteriorated. This deterioration is considered attributable to increase in distortion and decrease in accuracy of distortion compensation control in a transmission amplifier that are due to the drop in power supply voltage. When the ACLR has deteriorated, adjacent channels have larger influences on each other's communication than otherwise, possibly resulting in deterioration of communication quality. Not only that, deteriorated communication quality persists when an overcurrent has occurred and resulted in limitation of a current for charging the power supply capacitor to the extent that it takes a long time for the power supply voltage to recover.

Even if the technique for lowering a voltage control signal in accordance with an excess of the current from the current limitation reference value is used, it is difficult to prevent the power supply voltage from decreasing at the start of signal transmission in a base station device under the TDD scheme and therefore difficult to prevent deterioration of communication quality. Even if the conventional technique configured to temporarily increase an output voltage when the power supply voltage rises is used, the output voltage is not increased at the start of signal transmission, and it is difficult to prevent deterioration of communication quality.

### SUMMARY

According to an aspect of an embodiment, a voltage compensation circuit in a wireless communication device that performs wireless communication under a time division duplex (TDD) scheme includes: a first path that supplies power output from a power supply and having a first voltage; a second path that supplies power having a second voltage obtained by boosting the first voltage of the power output from the power supply; and a switching unit that switches the paths between the first path and the second path based on information on timing of switch from signal reception to signal transmission.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a base station device;

FIG. 2 is a block diagram of a voltage compensation circuit according to a first embodiment;

FIG. 3 is a diagram illustrating signal transmission and reception under the TDD scheme;

FIG. 4 is a timing chart for the operation of a voltage compensation circuit according to the embodiment;

FIG. 5 is a diagram illustrating the status of the voltage compensation circuit at a clock time t1;

FIG. 6 is a diagram illustrating the status of the voltage compensation circuit at a clock time t2;

FIG. 7 is a diagram illustrating the status of the voltage compensation circuit at a clock time t3;

FIG. 8 is a diagram illustrating the status of the voltage compensation circuit at a clock time t4;

FIG. 9 is a diagram illustrating the status of the voltage compensation circuit at a clock time t5;

FIG. 10 is a diagram illustrating the status of the voltage compensation circuit at a clock time t6;

FIG. 11 is a diagram illustrating the status of the voltage compensation circuit at a clock time t7;

FIG. 12 is a diagram illustrating the status of the voltage compensation circuit at a clock time t8;

FIG. 13 is a diagram illustrating the status of the voltage compensation circuit at a clock time t9; and

FIG. 14 is a block diagram of a voltage compensation circuit according to a second embodiment.

### DESCRIPTION OF EMBODIMENTS

Preferred embodiments of the present invention will be explained with reference to accompanying drawings. The following embodiments are not intended to limit the voltage compensation circuit, the wireless communication device, and the voltage compensation method disclosed by the present application.

### [a] First Embodiment

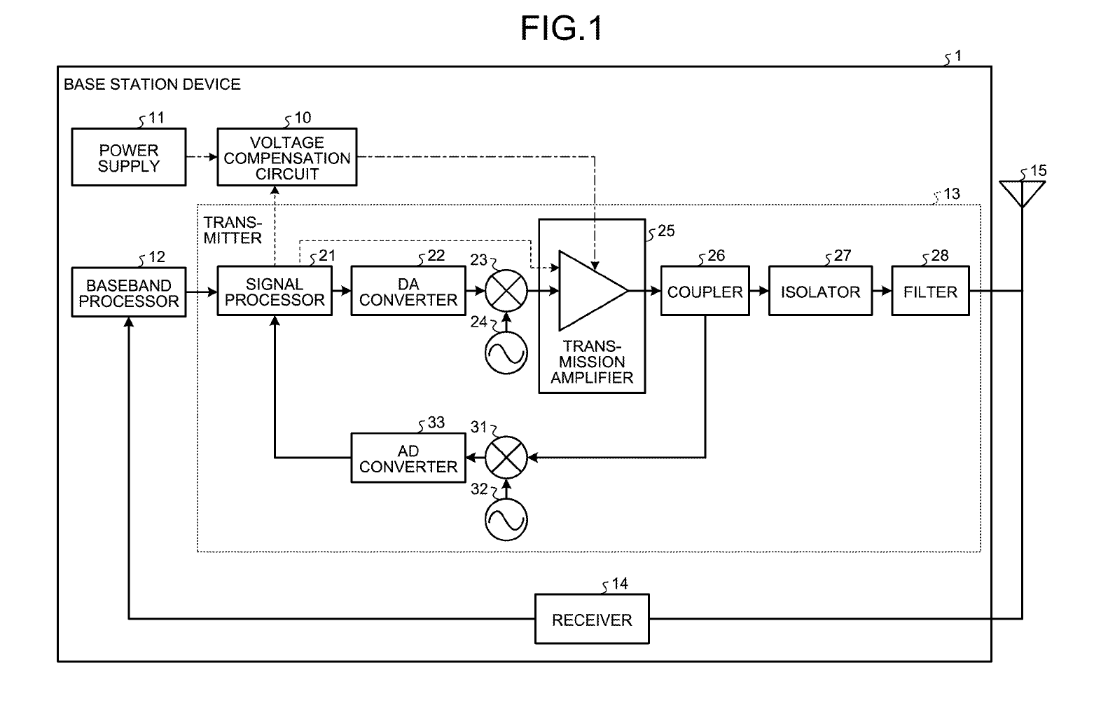

FIG. 1 is a block diagram of a base station device. A base station device 1 corresponds to an example of a “wireless communication device”. In FIG. 1, solid-line arrows indicate the path of a transmission signal. Broken-line arrows indicate the path of a control signal. Chain-line arrows indicate an electrical path.

As illustrated in FIG. 1, the base station device 1 includes a voltage compensation circuit 10, a power supply 11, a baseband processor 12, a transmitter 13, a receiver 14, and an antenna 15. The transmitter 13 includes a signal processor 21, a digital-to-analog (DA) converter 22, a mixer 23, an oscillator 24, a transmission amplifier 25, a coupler 26, an isolator 27, and a filter 28. The transmitter 13 further includes a mixer 31, an oscillator 32, and an analog-to-digital (AD) converter 33. The transmitter 13 and the receiver 14 operate using power supplied from, for example, at least one of the power supply 11, a power supply that is not the power supply 11, and a part of output from the voltage compensation circuit 10 (not illustrated in the drawing).

The baseband processor 12 modulates and encodes a baseband signal serving as a transmission signal. The baseband processor 12 outputs the modulated and encoded baseband signal to the signal processor 21 of the transmitter 13.

The baseband processor 12 receives, from the receiver 14, input of a baseband signal serving as a reception signal. The baseband processor 12 decodes and demodulates the baseband signal serving as a reception signal.

The signal processor 21 is implemented by a field programmable gate array (FPGA) or the like. The signal processor 21 receives, from the baseband processor 12, input of a baseband signal serving as a transmission signal. The signal processor 21 receives input of a feedback signal from the AD converter 33. The signal processor 21 then uses the difference between the acquired baseband signal and feedback signal to compensate the distortion of the acquired baseband signal. The signal processor 21 then outputs the distortion-compensated baseband signal to the DA converter 22.

The signal processor 21 previously stores therein when to switch communication under the TDD scheme between signal transmission and reception. When to switch communication between transmission and reception that is previously stored is, for example, timing of cyclic switching or timing prescribed by the technical standards. The signal processor 21 then outputs a transmission/reception switching advance-notification signal to the voltage compensation circuit 10 a certain period of time before the start of signal transmission. The certain period of time is set to, for example, 0.3 ms. Thereafter, after the elapse of an previously determined advance-notification announcement period starting from the start of signal transmission, the signal processor 21 stops outputting the transmission/reception switching advance-notification signal. As described later, it is preferable that the advance-notification announcement period be longer than a period starting at the start of signal transmission until a voltage output from the power supply 11 returns to a standard voltage after a switch 104 is turned on or off, the standard voltage being a voltage with which a load can appropriately operate. As the advance-notification announcement period, any desired period can be used that enables output of a transmission/reception switching advance-notification signal to be stopped before the elapse of a certain period starting when the next signal transmission is started.

At the start of signal transmission, the signal processor 21 transmits a signal for turning the operation thereof off to the transmission amplifier 25, thereby turning the transmission amplifier 25 off. Also at the start of signal reception, the signal processor 21 transmits a signal for turning the operation thereof on to the transmission amplifier 25, thereby turning the transmission amplifier 25 on. Turning the transmission amplifier 25 off can result in reduction of the amount of power consumed by the transmission amplifier 25 during the signal transmission, and can lead to reduction in power consumption.

The DA converter 22 receives input of a baseband signal from the signal processor 21. The DA converter 22 then converts the acquired baseband signal from a digital signal to an analog signal. Thereafter, the DA converter 22 outputs the baseband signal converted into an analog signal to the mixer 23.

The oscillator 24 outputs a previously determined frequency. The mixer 23 receives input of a baseband signal from the DA converter 22. The mixer 23 then mixes the frequency output by the oscillator 24 and the frequency of the baseband signal, thereby changing the frequency of the baseband signal to create a radio frequency (RF) signal. Thereafter, the mixer 23 outputs the generated RF signal to the transmission amplifier 25.

The transmission amplifier 25 is driven by power supplied from the voltage compensation circuit 10 to be described later. The transmission amplifier 25 receives input of an RF signal from the mixer 23. The transmission amplifier 25 then amplifies the received RF signal. Thereafter, the transmission amplifier 25 outputs the amplified RF signal to the coupler 26.

The coupler 26 receives input of an RF signal serving as a transmission signal, from the transmission amplifier 25. The coupler 26 then outputs the received RF signal to the isolator 27 and the mixer 31.

The isolator 27 receives input of an RF signal serving as a transmission signal, from the coupler 26. The isolator 27 then matches impedances for the RF signal. Thereafter, the isolator 27 outputs the RF signal to the filter 28.

The filter 28 receives, from the isolator 27, input of an RF signal serving as a transmission signal. The filter 28 then performs filter processing on the acquired RF signal, thereby limiting the RF signal to a previously determined frequency band. The filter 28 then transmits the RF signal through the antenna 15.

The oscillator 32 outputs a previously determined frequency. The mixer 31 receives input of an RF signal serving as a transmission signal, from the coupler 26. The mixer 31 then mixes the frequency output by the oscillator 32 and the frequency of the RF signal, thereby changing the frequency of the RF signal to create a baseband signal that serves as a feedback signal. Thereafter, the mixer 31 outputs the generated baseband signal to the AD converter 33.

The AD converter 33 receives, from the mixer 31, input of a baseband signal serving as a feedback signal. The AD converter 33 then converts the received baseband signal from an analog signal to a digital signal. Thereafter, the AD converter 33 outputs the baseband signal to the signal processor 21.

The receiver 14 operates using power supplied from the voltage compensation circuit 10. The receiver 14 receives a signal through the antenna 15. The receiver 14 then performs filter processing, frequency conversion, and AD conversion on an RF signal serving as a reception signal, thereby generating a baseband signal. The receiver 14 then outputs the baseband signal serving as a reception signal to the baseband processor 12.

The power supply 11 supplies power to the voltage compensation circuit 10. When an increase in power demanded from the power supply 11 has resulted in, for example, an increase in current supplied therefrom and thereby resulted in a drop in voltage thereof, the power supply 11 performs voltage control in which the level of supplied voltage is controlled, so that the power supply voltage is increased. The power supply 11 is then restored to a standard voltage, which is a voltage that can bring a load to proper operation. Hereinafter, a voltage output by the power supply 11 is referred to as a “power supply voltage”.

The voltage compensation circuit 10 receives power supplied from the power supply 11. The voltage compensation circuit 10 supplies power to the transmission amplifier 25.

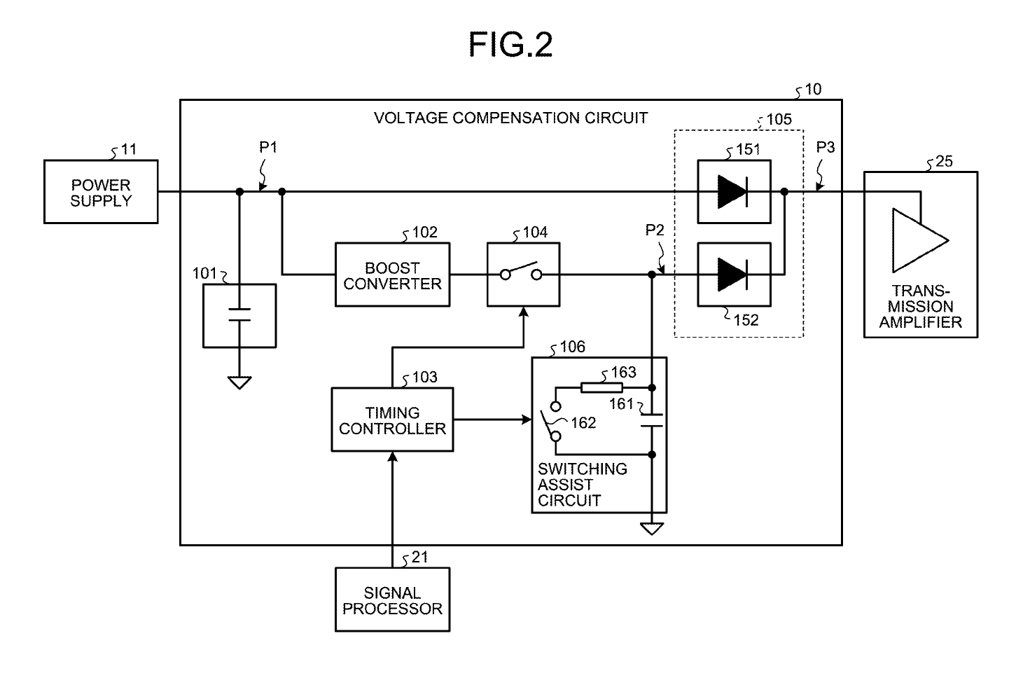

With reference to FIG. 2, the voltage compensation circuit 10 is described in detail. FIG. 2 is a block diagram of the voltage compensation circuit according to the first embodiment. In FIG. 2, solid-line arrows indicate the flow of a control signal. The voltage compensation circuit 10 according to this embodiment includes a power supply capacitor 101, a boost converter 102, a timing controller 103, a switch 104, an ORing circuit 105, and a switching assist circuit 106 as illustrated in FIG. 2.

There are two paths between the power supply 11 and the transmission amplifier 25 that connect them together in parallel, one of the paths directly connecting them together via a diode 151 and another one thereof connecting them together via the boost converter 102, the switch 104, and a diode 152. Here, directly connecting together the power supply 11 and the transmission amplifier 25 means that the boost converter 102 is not placed therebetween.

The power supply capacitor 101 is placed between the ground and a position between the power supply 11 and the branching point of the two paths for supplying power from the power supply 11 to the transmission amplifier 25. The power supply capacitor 101 is charged by storing therein electric charge output from the power supply 11. It is to be noted that the power supply capacitor 101 is charged with a residual load current only while the power supply 11 is supplying power to the transmission amplifier 25. Upon completion of the charging, the power supply capacitor 101 stops receiving power supplied from the power supply 11.

The power supply capacitor 101 discharges the stored electric charge when there is no current flowing out from the power supply 11. Power output from the power supply capacitor 101 is supplied to the transmission amplifier 25 via the boost converter 102 if the switch 104 is on. When a current from the power supply 11 has recovered, the power supply capacitor 101 stops discharging electric charge and transitions to a state of being charged.

The boost converter 102 is placed in parallel to the path that directly connects together the power supply 11 and the transmission amplifier 25. The boost converter 102 boosts the voltage of electricity input thereto to a certain voltage and outputs the certain voltage. The boost converter 102 does not receive input of electricity if the switch 104 is off. Otherwise, if the switch 104 is on and if no current is flowing from the power supply 11, the boost converter 102 receives input of electricity output from the power supply capacitor 101. Otherwise, if the switch 104 is on and if a current from the power supply 11 is restored, the boost converter 102 receives input of electricity output from the power supply 11.

The timing controller 103 is implemented in the form of an FPGA, an embedded circuit, a central processing unit (CPU), or the like. The timing controller 103 previously stores thereon a boost-on standby time and a boost-off standby time. The boost-on standby time is a standby time starting when a transmission/reception switching advance-notification signal is received and ending when the switch 104 is turned on thereafter. The boost-off standby time is a standby time starting when the switch 104 is turned on and ending when the switch 104 is turned off thereafter. The timing controller 103 also previously stores thereon a discharge-cancellation standby time that is a standby time starting when a switch 162 is turned on and ending when the switch 162 is after turned off.

The timing controller 103 receives input of the transmission/reception switching advance-notification signal from the signal processor 21 a certain time period before the start of signal transmission. The timing controller 103 then turns on the switch 104 right after the elapse of the boost-on standby time starting when the transmission/reception switching advance-notification signal is received.

Thereafter, the timing controller 103 turns the switch 104 off right after the elapse of the boost-off standby time starting when the switch 104 is turned on. In this case, the boost converter 102 boosts a voltage, and power consumption increases in a signal-transmitting state. For this reason, the boost-off standby time is preferably determined so that the switch 104 may be turned off immediately after switching to the signal-transmitting state. In this case, if a capacitor 161 has not yet stored a certain amount of charge, the switching is not performed until the certain amount of electric charge is stored. This makes it possible to stably store electric charge. The certain amount of electric charge stored in the capacitor 161 is preferably an amount that allows power supply to the transmission amplifier 25 to continue until the power supply voltage recovers to the standard voltage after the turning off of the switch 104.

Thereafter, right after the elapse of an advance-notification announcement period starting when the transmission/reception switching advance-notification signal is received, input of the transmission/reception switching advance-notification signal to the timing controller 103 from the signal processor 21 is stopped. Here, a period obtained by subtracting the boost-on standby time and the boost-off standby time from the advance-notification announcement period, that is, a standby time staring when the switch 104 is turned off and ending when the switch 162 of the switching assist circuit 106 is turned on is referred to as an “assist-off standby time”.

In response to the stoppage of input of the transmission/reception switching advance-notification signal, the timing controller 103 turns on the switch 162 of the switching assist circuit 106. Here, as described in connection with the advance-notification announcement period, the assist-off standby time is preferably set so that the switch 162 may be turned on after the power supply voltage recovers to the standard voltage. In particular, the assist-off standby time is preferably set so that the switch 162 may be turned on right at the time when the power supply voltage recovers to the standard voltage. In this embodiment, the timing controller 103 turns the switch 162 on in response to the stoppage of input of the transmission/reception switching advance-notification signal, but may turn it on alternatively in another manner. For example, the timing controller 103 may be configured to previously store therein the assist-off standby time and, after turning off the switch 104, turn on the switch 162 after the elapse of the assist-off standby time.

Thereafter, the timing controller 103 turns the switch 162 on and then, right after the elapse of the discharge-cancellation standby time, turns off the switch 162. Here, the discharge-cancellation standby time can be set so as to allow the switch 162 to be turned off at any appropriate time after a current path in the ORing circuit 105 to be described later is switched to a path that goes through the diode 151.

The switch 104 is placed on a path that connects the boost converter 102 and the diode 152, that is, one of the diodes in the ORing circuit 105, to each other. The switch 104 is turned on and off, so that the path that connects the boost converter 102 and the diode 152, one of the diodes in the ORing circuit 105, to each other is switched between connection and disconnection. The switch 104 is switched between being on and off under the control of the timing controller 103.

Specifically, with the base station device 1 being in a signal-receiving state, the switch 104 receives input of the transmission/reception switching advance-notification signal from the signal processor 21 and then, after the elapse of the boost-on standby time, is turned on under the control of the timing controller 103. Thereafter, with the base station device 1 being in a signal-transmitting state, when input of transmission/reception switching advance-notification signal to the timing controller 103 is stopped after the elapse of the advance-notification announcement period starting from the input of the transmission/reception switching advance-notification signal, the switch 104 is turned off under the control of the timing controller 103.

The ORing circuit 105 includes the diodes 151 and 152. The ORing circuit 105 outputs power from electricity output from the diode 151 or power from electricity output from the diode 152 that has a higher potential than the other.

The diode 151 is placed on the path that directly connects together the power supply 11 and the transmission amplifier 25. The diode 151 outputs electricity having the power supply voltage output from the power supply 11.

The diode 152 is placed between the switch 104 and the transmission amplifier 25. If the switch 104 is on, the diode 152 outputs electricity the voltage of which has been boosted by the boost converter 102. Otherwise, if the switch 104 is off with the switch 162 of the switching assist circuit 106 being off, the diode 152 outputs electricity output by the capacitor 161 in the switching assist circuit 106. Otherwise, if the switch 104 is off with the switch 162 of the switching assist circuit 106 being on, the diode 152 does not output electricity.

Each of the diodes 151 and 152 may be built as a virtual diode, for example, by combining a transistor and an integrated circuit.

The switching assist circuit 106 is a circuit for allowing the power supply capacitor 101 to be charged with electricity output from the power supply 11, quickly charging the power supply capacitor 101, and quickly restoring power supply using the path that goes through the diode 151. The switching assist circuit 106 includes the capacitor 161, the switch 162, and a resistor 163.

The capacitor 161 is placed on a path that connects the ground and a point in an intermediate part of the path that connects the switch 104 and the diode 152. The capacitor 161 is charged with electricity output from the boost converter 102 while the switch 104 is on. Thereafter, when the switch 104 is off, the capacitor 161 discharges electric charge stored therein. Thereafter, when the switch 162 is on, the capacitor 161 discharges the electric charge to a path composed of the resistor 163 and the switch 162.

The switch 162 is placed in parallel to the capacitor 161. The switch 162 is switched between being on and off under the control of the timing controller 103. Specifically, the switch 162 is off at the time of turning the switch 104 on. Thereafter, right after the elapse of the assist-off standby time starting when the switch 104 is turned off, the switch 162 is switched on. Right after the elapse of the discharge-cancellation standby time starting when the switch 162 is switched on, the switch 162 is switched off.

The resistor 163 is placed between the capacitor 161 and the switch 162. Electricity output from the capacitor 161 flows through the resistor 163, so that electricity is discharged from the capacitor 161.

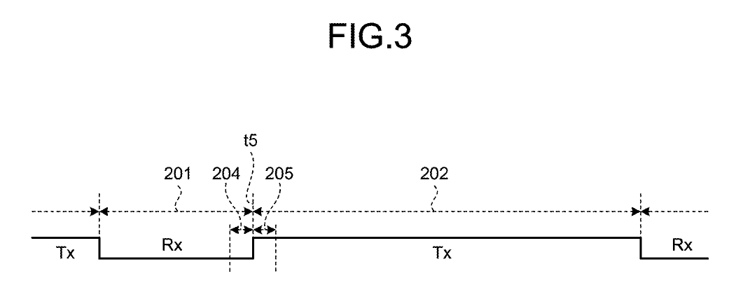

Next, with reference to FIGS. 3 to 13, the sequence of the operation of the voltage compensation circuit 10 according to this embodiment et the time of switching between the signal reception state and the signal transmission state.

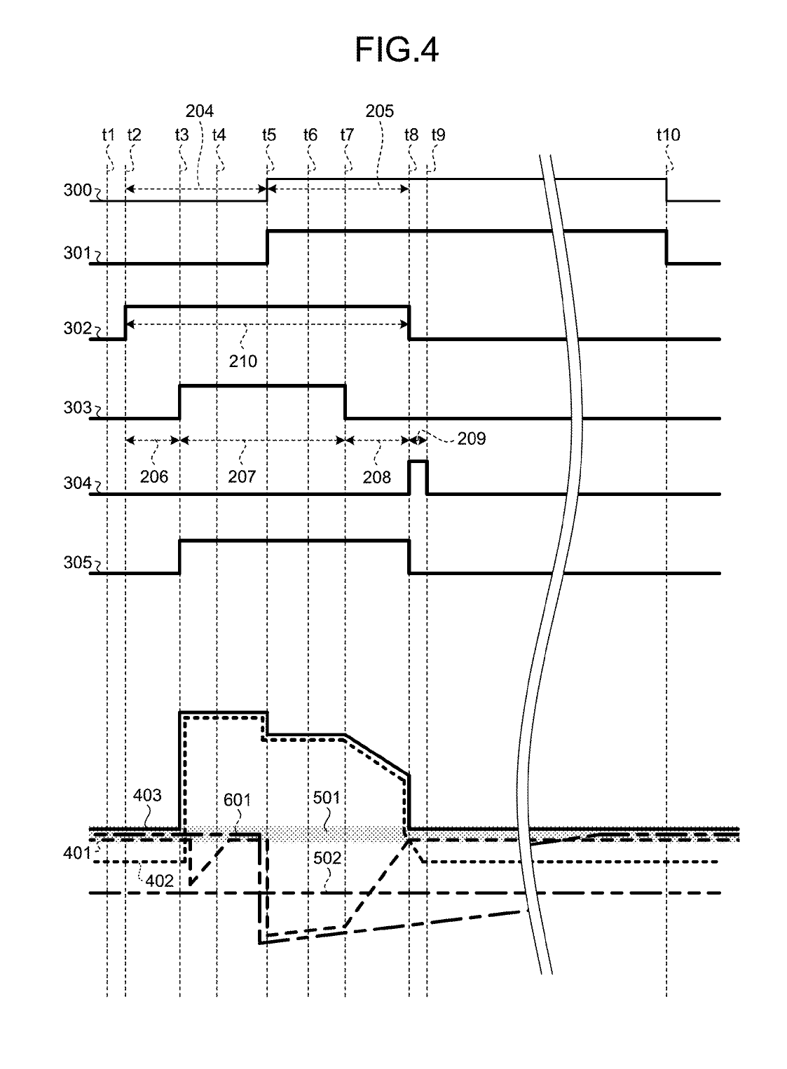

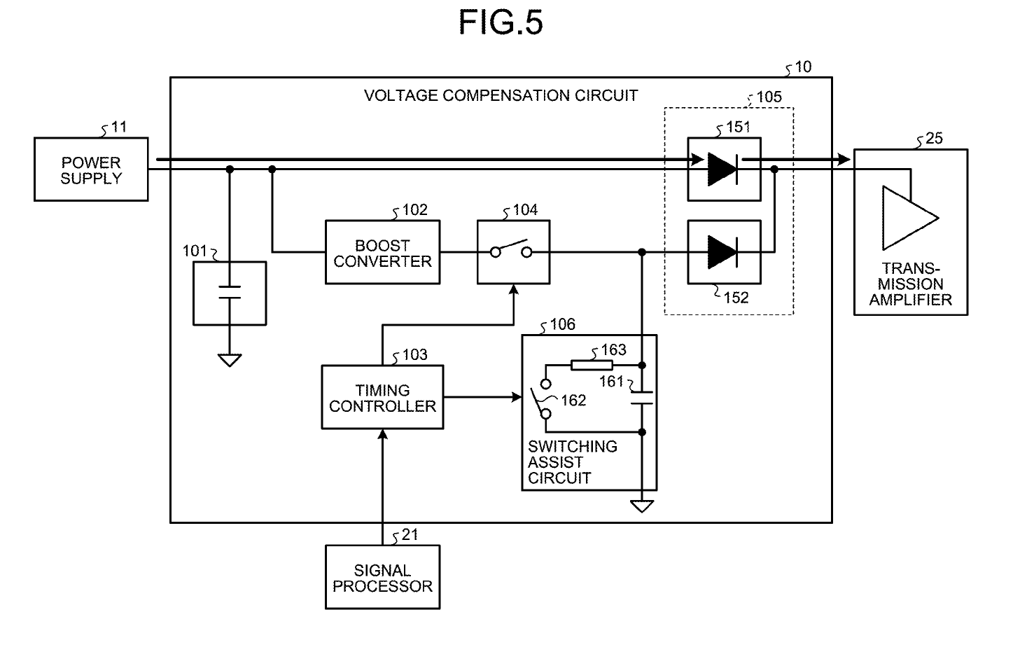

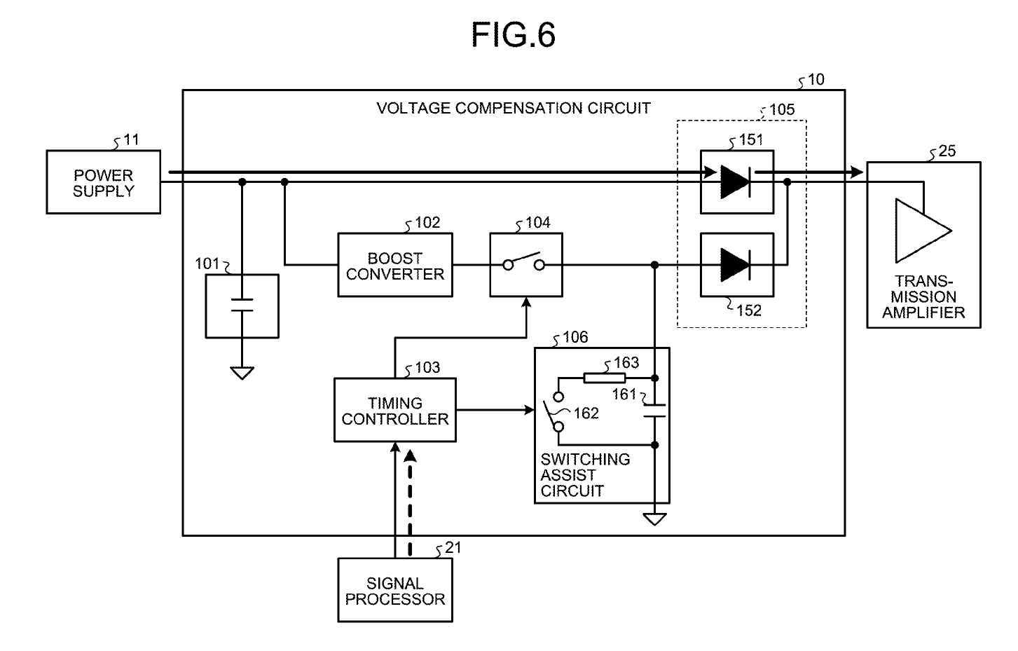

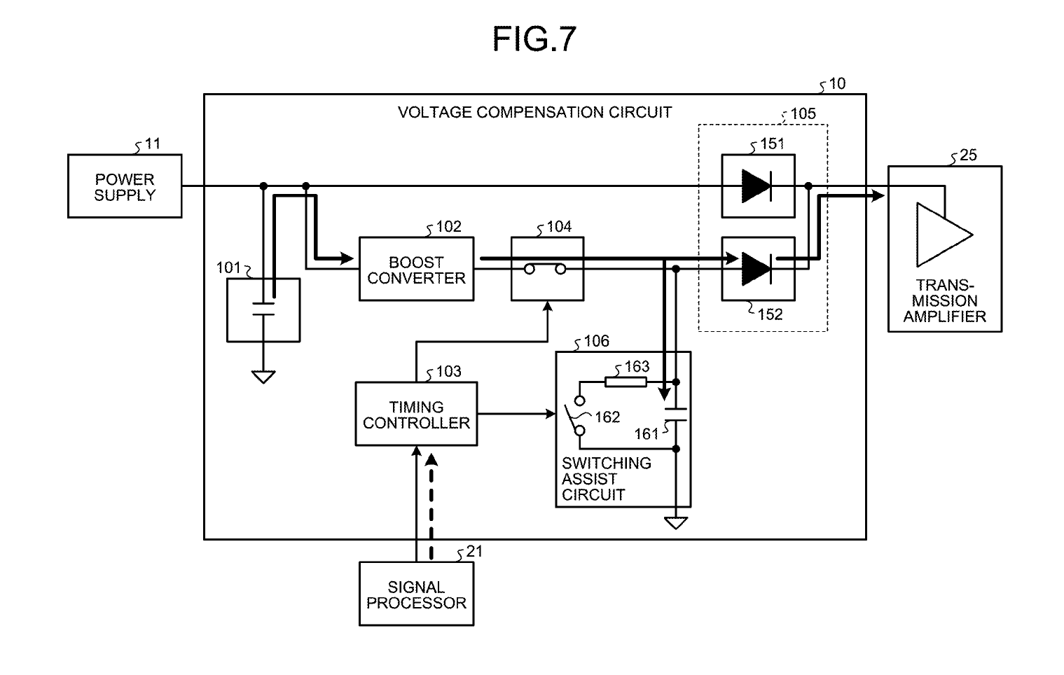

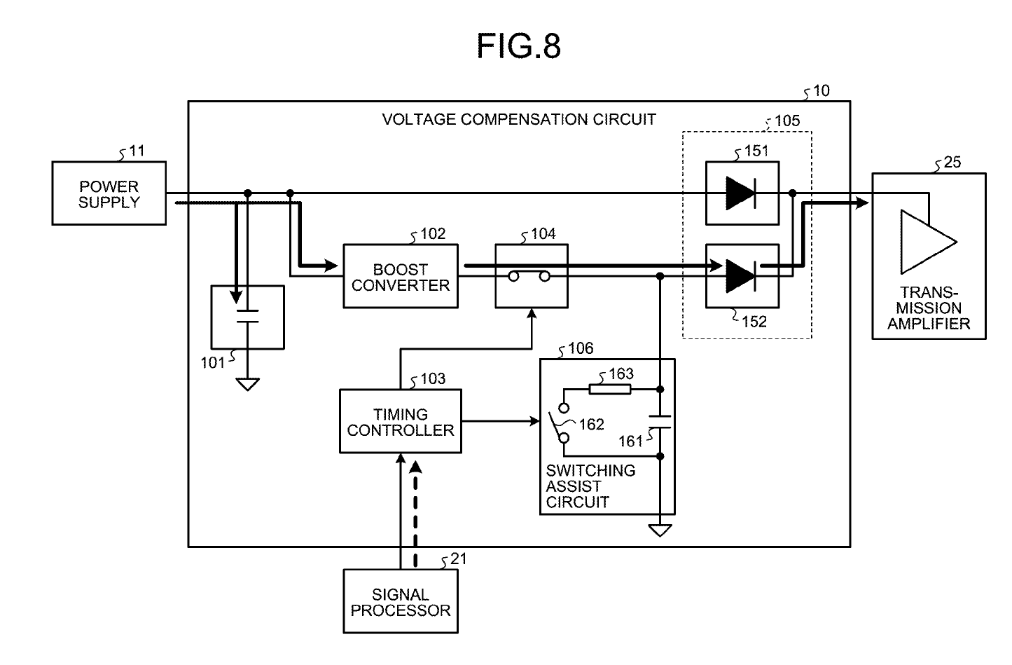

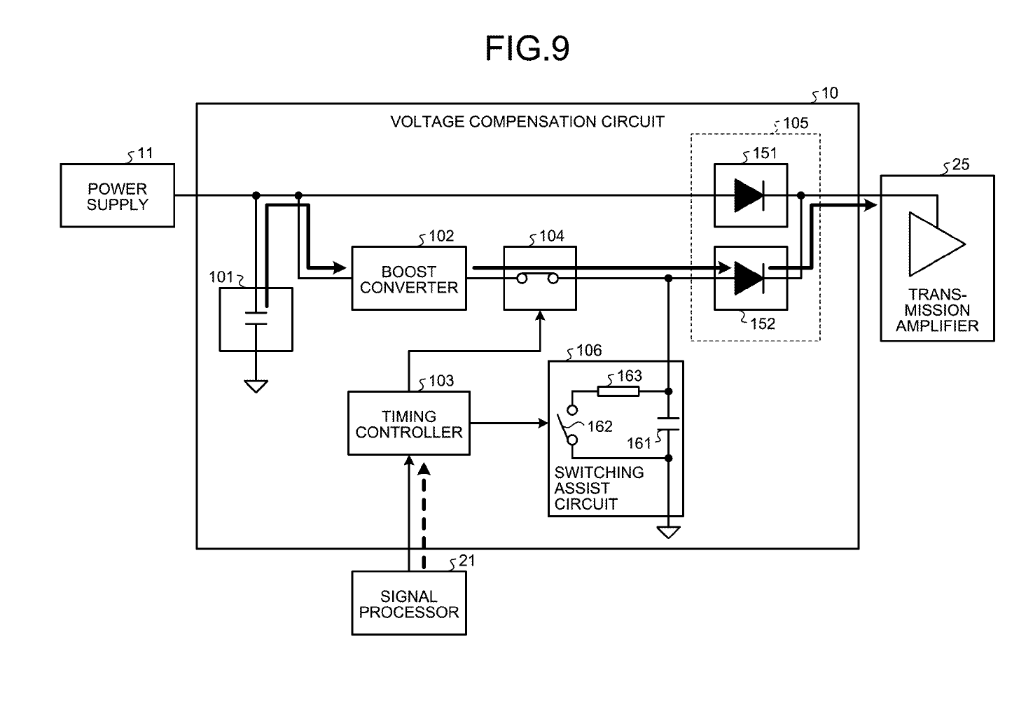

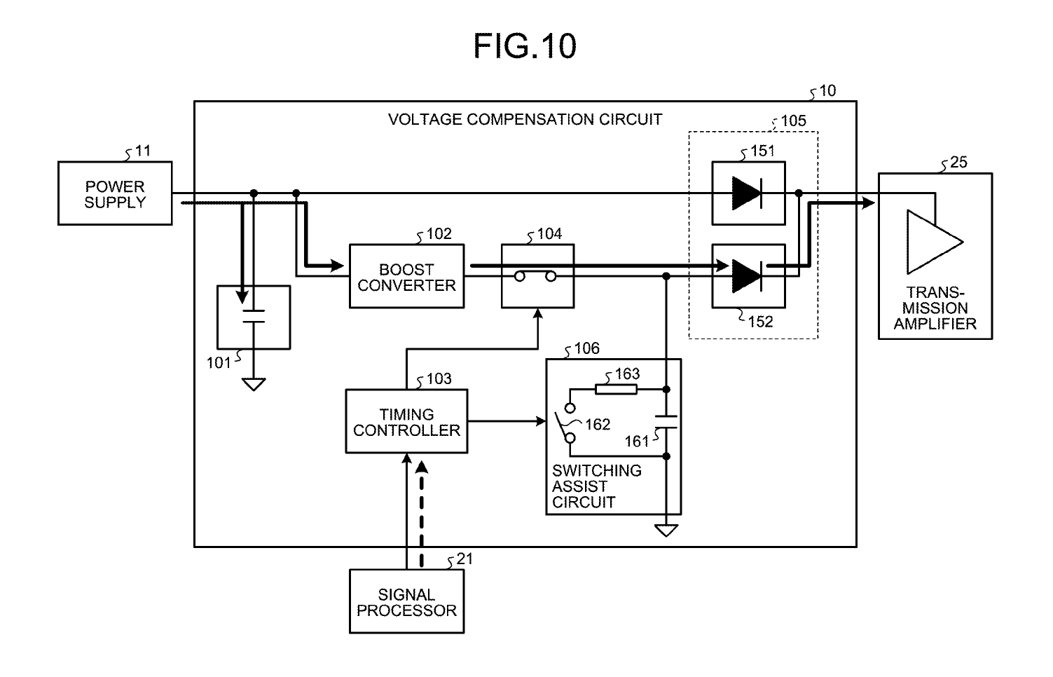

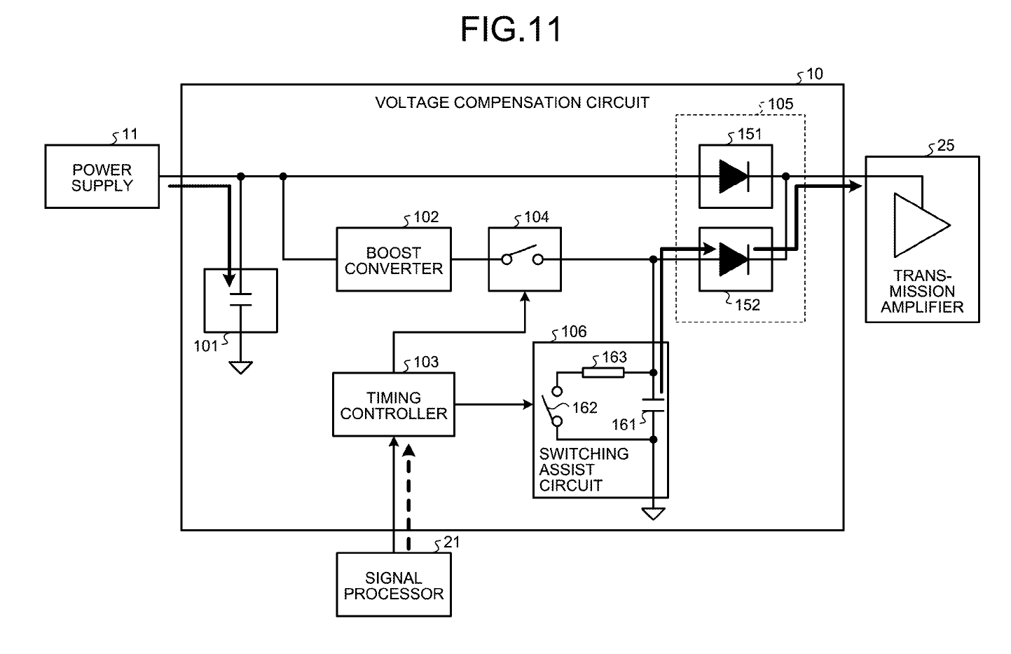

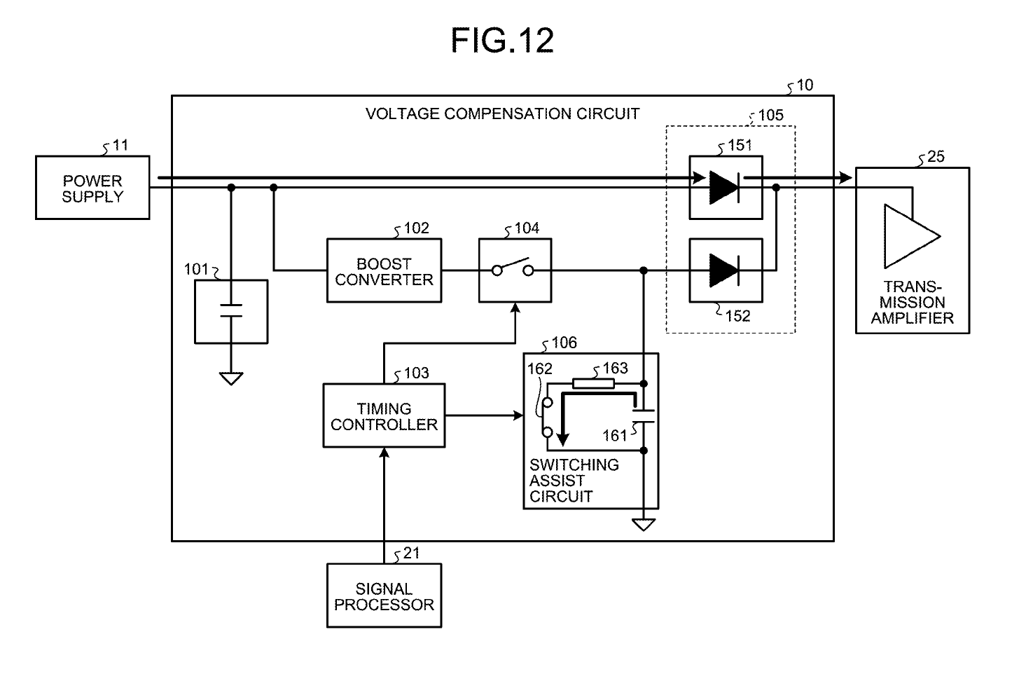

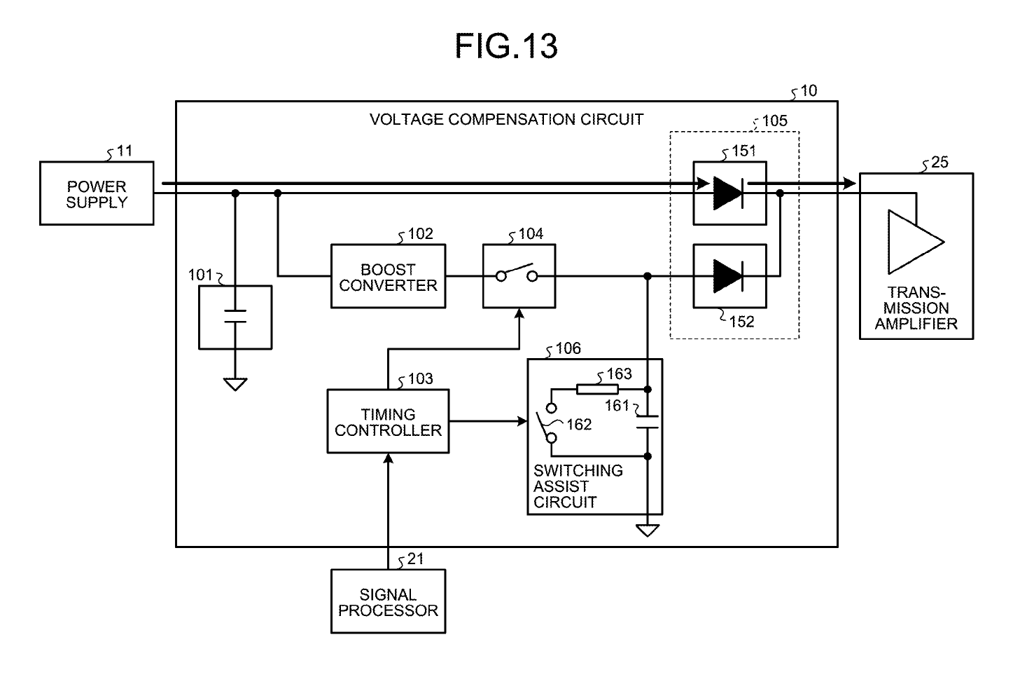

FIG. 3 is a diagram illustrating signal transmission and reception under the TDD scheme. FIG. 4 is a timing chart for the operation of the voltage compensation circuit according to the embodiment. FIG. 5 is a diagram illustrating the status of the voltage compensation circuit at a clock time t1. FIG. 6 is a diagram illustrating the status of the voltage compensation circuit at a clock time t2. FIG. 7 is a diagram illustrating the status of the voltage compensation circuit at a clock time t3. FIG. 8 is a diagram illustrating the status of the voltage compensation circuit at a clock time t4. FIG. 9 is a diagram illustrating the status of the voltage compensation circuit at a clock time t5. FIG. 10 is a diagram illustrating the status of the voltage compensation circuit at a clock time t6. FIG. 11 is a diagram illustrating the status of the voltage compensation circuit at a clock time t7. FIG. 12 is a diagram illustrating the status of the voltage compensation circuit at a clock time t8. FIG. 13 is a diagram illustrating the status of the voltage compensation circuit at a clock time t9. In FIGS. 5 to 13, bold solid lines indicate flows of electricity. Each bold broken line indicates a state where a control signal has been transmitted.

As illustrated in FIG. 3, the base station device 1 repeats reception of signals by the receiver (Rx) 14 and transmission of signals by the transmitter (Tx) 13. For example, the receiver 14 performs reception of signals during a period 201. The transmitter 13 performs transmission of signals during a period 202. The period 201 is, for example, 1.27 ms. The period 202 is, for example, 3.73 ms.

In this case, the base station device 1 switches at the clock time t5 from reception of signals by the receiver 14 to transmission of signals by the transmitter 13. Subsequently, in the base station device 1 according to this embodiment, the transmission/reception switching advance-notification signal for announcing an advance notification on switching from signal reception to signal transmission is delivered from the signal processor 21 to the timing controller 103, for example, at a point in time that is a period 204 before the clock time t5. Thereafter, at a point in time when a period 205 starting from the clock time t5 elapses, input of the transmission/reception switching advance-notification signal is stopped. That is, the aggregate of the period 204 and the period 205 is the advance-notification announcement period. For example, the periods 204 and 205 are each set to 0.3 ms.

Next, with reference to FIG. 4, the status of signals and the status of voltage at each clock time are described. FIG. 4 is a diagram illustrating parts in FIG. 3 that correspond to the periods 204 and 205, in an enlarged fashion. A graph 300 represents the status of signal transmission and reception in the base station device 1. That is, the graph 300 corresponds to FIG. 3, and the base station device 1 is in the signal-receiving state when the graph 300 is at a low level. When the graph 300 is at a high level, the base station device 1 is in the signal-transmitting state.

A graph 301 represents the status of the transmitter 13 in terms of signal transmission. That is, when the graph 301 is at a low level, the transmitter 13 does not transmit any signals. When the graph 301 is at a high level, the transmitter 13 performs signal transmission.

The graph 302 represents whether the transmission/reception switching advance-notification signal is being input. When the graph 302 is at a high level, the transmission/reception switching advance-notification signal is input to the timing controller 103. When the graph 302 is at a low level, input of the transmission/reception switching advance-notification signal to the timing controller 103 is stopped.

A graph 303 represents whether the switch 104 is on or off. In other words, the graph 303 represents whether a boosted voltage output from the boost converter 102 is supplied to the transmission amplifier 25. When the graph 303 is at a high level, the switch 104 is on, a boosted voltage output from the boost converter 102 is supplied to the transmission amplifier 25. When the graph 303 is at a low level, the switch 104 is off, supply of a boosted voltage output from the boost converter 102 to the transmission amplifier 25 is stopped.

Here, a period 206 from a clock time t2 when the transmission/reception switching advance-notification signal is input to the timing controller 103 to a clock time t3 when the timing controller 103 turns the switch 104 on is the boost-on standby time. A period 207 from the clock time t3 when the timing controller 103 turns the switch 104 on to a clock time t7 when the timing controller 103 turns the switch 104 off is the boost-off standby time.

A graph 304 represents whether the switch 162 is on or off. In other words, the graph 304 represents whether electric charge stored in the capacitor 161 is discharged. When the graph 304 is at a high level, the switch 162 is on, and electric charge stored in the capacitor 161 is discharged. When the graph 304 is at a low level, the switch 162 is off, and discharge of electric charge stored in the capacitor 161 is stopped. Here, a period 208 from the clock time t7 when the timing controller 103 turns the switch 104 off to a clock time t8 when the timing controller 103 turns the switch 162 on is the assist-off standby time. A period 209 from the clock time t8 when the timing controller 103 turns the switch 162 on to a clock time t9 when the timing controller 103 turns the switch 162 off is the discharge-cancellation standby time.

The aggregate of the periods 206 to 208 corresponds to the aggregate of the periods 204 and 205, which is A advance-notification announcement period 210 starting when the signal processor 21 starts transmitting the transmission/reception switching advance-notification signal to the timing controller 103 and ending when the signal processor 21 stops the transmission.

A graph 305 represents which of the path that goes through the diode 151 and the path that goes through the diode 152 is used as a power supply path in the ORing circuit 105. When the graph 305 is at a high level, the path that goes through the diode 152 is used, that is, a boosted voltage is supplied to the transmission amplifier 25. When the graph 305 is at a low level, the path that goes through the diode 151 is used, that is, a power supply voltage is supplied to the transmission amplifier 25 without being boosted.

A graph 401 represents changes in voltage Vp measured at the point P1 in FIG. 2. A graph 402 represents changes in voltage Vb measured at the point P2 in FIG. 2. A graph 403 represents changes in voltage VI measured at the point P3 in FIG. 2. A graph 601 represents changes in voltage Va supplied to the transmission amplifier 25 in a case using a conventional technique and measured at a point corresponding to the point P3 in FIG. 2.

Furthermore, the line 501 represents a standard voltage. Here, in order to illustrate a state where the individual voltages are equal to the standard voltage, FIG. 4 illustrates the line 501 as ranging in width. Actually, however, the standard voltage is determined to be one value. A line 502 represents the minimum operating voltage.

First, the status in terms of signals and the status in terms of voltage are described at a clock time t1 before the transmission/reception switching advance-notification signal is input. At the clock time t1, the voltage compensation circuit 10 is in a state illustrated in FIG. 5. That is, the switch 104 and the switch 162 are off, and power-supply voltage output from the power supply 11 is supplied to the transmission amplifier 25 via the diode 151.

At the clock time t1, as represented by the graphs 300 and 301 in FIG. 4, the base station device 1 is in the signal-receiving state, and the transmitter 13 does not transmit any signals. As represented by the graph 302, the transmission/reception switching advance-notification signal has not yet been input to the timing controller 103. As represented by the graph 303, the switch 104 is off. As represented by the graph 304, the switch 162 is off. In addition, as represented by the graph 305, the power supply voltage output from the diode 151 is supplied to the transmission amplifier 25.

Furthermore, at the clock time t1, the voltage Vp is the power-supply voltage output from the power supply 11 and is the standard voltage, as represented by the graph 401. The voltage Vb is voltage lower than the standard voltage on account of electric charge remaining in the capacitor 161, as represented by the graph 402. In this case, the voltage Vp is higher than the voltage Vb, so that the voltage VI coincides with the voltage Vp as represented by the graph 403.

Thereafter, at the clock time t2 that is the period 204, or a certain period, before the clock time t5 that is the timing of switch the signal transmission and reception, the timing controller 103 receives input of the transmission/reception switching advance-notification signal from the signal processor 21. At the clock time t2, the voltage compensation circuit 10 is in a state illustrated in FIG. 6. That is, the timing controller 103 receives input of the transmission/reception switching advance-notification signal from the signal processor 21 in a state where the power supply voltage output from the power supply 11 is being supplied to the transmission amplifier 25 via the diode 151 with the switch 104 and the switch 162 being off.

At the clock time t2, as represented by the graphs 300 and 301 in FIG. 4, the base station device 1 is in the signal-receiving state, and the transmitter 13 does not transmit any signals. As represented by the graph 302, input of the transmission/reception switching advance-notification signal to the timing controller 103 is started. As represented by the graph 303, the switch 104 is off. As represented by the graph 304, the switch 162 is off. In addition, as represented by the graph 305, the power supply voltage output from the diode 151 is supplied to the transmission amplifier 25.

Furthermore, at the clock time t2, the voltage measured at each of the points P1 to P3 is unchanged from that at the clock time t1. That is, the voltage Vp is the power-supply voltage output from the power supply 11 and is the standard voltage, as represented by the graph 401. The voltage Vb is voltage lower than the standard voltage on account of electric charge remaining in the capacitor 161, as represented by the graph 402. In this case, the voltage Vp is higher than the voltage Vb, so that the voltage VI coincides with the voltage Vp as represented by the graph 403.

At the clock time t3 when the period 206, or the boost-on standby time, starting from the clock time t2 elapses, the timing controller 103 turns the switch 104 on. At the clock time t3, the voltage compensation circuit 10 is in a state illustrated in FIG. 7. That is, the switch 104 is turned on. The switch 162 is off. In this case, a current larger than before this time clock flows because power is supplied to the transmission amplifier 25 and the capacitor 161. For this reason, the power supply 11 fails to perform voltage control without delay and stops outputting power. Power then starts being supplied from the power supply capacitor 101. The voltage of electricity output from the power supply capacitor 101 is boosted by the boost converter 102, and the electricity is supplied to the diode 152 and the capacitor 161 via the switch 104. Electricity supplied to the diode 152 is fed to the transmission amplifier 25. Electricity supplied to the capacitor 161 is stored as electric charge in the capacitor 161.

At the clock time t3, as represented by the graphs 300 and 301 in FIG. 4, the base station device 1 is in the signal-receiving state, and the transmitter 13 does not transmit any signals. As represented by the graph 302, input of the transmission/reception switching advance-notification signal to the timing controller 103 is continued. As represented by the graph 303, the switch 104 is turned on. As represented by the graph 304, the switch 162 is kept off. In addition, as represented by the graph 305, power supply paths in the ORing circuit 105 are switched, so that the boosted voltage is output from the diode 152 and supplied to the transmission amplifier 25.

Furthermore, at the clock time t3, the voltage Vp drops as represented by the graph 401 because, as a result of an increase in the current, power stops being supplied from the power supply 11 and is replaced by power supplied from the power supply capacitor 101. The voltage Vb sharply increases as represented by the graph 402 because electricity output from the power supply capacitor 101 is supplied with the voltage thereof boosted. In this case, the voltage Vb is higher than the voltage Vp, so that the voltage VI coincides with the voltage Vb as represented by the graph 403.

At the clock time t4 that is some time after the clock time t3 and is when the power supply voltage output from the power supply 11 has increased, the voltage compensation circuit 10 is in a state illustrated in FIG. 8. That is, the switch 104 is on. The switch 162 is off. In this case, the power supply voltage output from the power supply 11 has sufficiently increased, and therefore is supplied to the power supply capacitor 101 and the boost converter 102. The power supply voltage supplied to the power supply capacitor 101 is stored as electric charge in the power supply capacitor 101. The power supply voltage supplied to the boost converter 102 is boosted and then fed to the transmission amplifier 25 via the switch 104 and the diode 152. In this case, charging of the capacitor 161 has been already completed.

At the clock time t4, as represented by the graphs 300 and 301 in FIG. 4, the base station device 1 is in the signal-receiving state, and the transmitter 13 transmits no signal. As represented by the graph 302, input of the transmission/reception switching advance-notification signal to the timing controller 103 is continued. As represented by the graph 303, the switch 104 is kept on. As represented by the graph 304, the switch 162 is kept off. In addition, as represented by the graph 305, a boosted voltage is output from the diode 152 and supplied to the transmission amplifier 25.

Furthermore, at the clock time t4, the voltage Vp is gradually increasing as represented by the graph 401 because of voltage control performed thereon by the power supply 11. The voltage Vb is obtained by boosting the power supply voltage and then supplied, and therefore is maintained as a high voltage as represented by the graph 402. In this case, the voltage Vb is higher than the voltage Vp, so that the voltage VI coincides with the voltage Vb as represented by the graph 403.

At the clock time t5 when a certain period, or the period 204, starting from the clock time t2 that is when the transmission/reception switching advance-notification signal starts being input to the timing controller 103 elapses, switch between signal transmission and reception occurs. As a result, the receiver 14 stops signal reception and the transmitter 13 starts signal transmission. At the clock time t5, the voltage compensation circuit 10 is in a state illustrated in FIG. 9. That is, the switch 104 is kept on. The switch 162 is kept off. In this case, the transmitter 13 starts signal transmission, so that the transmission amplifier 25 starts consuming power, resulting in a sharp increase in the current. For this reason, the power supply 11 fails to perform voltage control without delay and stops outputting power. Power then starts being supplied from the power supply capacitor 101. The voltage of electricity output from the power supply capacitor 101 is boosted by the boost converter 102, and the electricity is then supplied to the transmission amplifier 25 via the switch 104 and the diode 152.

At the clock time t5, as represented by the graphs 300 and 301 in FIG. 4, the base station device 1 is switched to the signal-transmitting state, and the transmitter 13 starts signal transmission. As represented by the graph 302, input of the transmission/reception switching advance-notification signal to the timing controller 103 is continued. As represented by the graph 303, the switch 104 is kept on. As represented by the graph 304, the switch 162 is kept off. In addition, as represented by the graph 305, a boosted voltage is output from the diode 152 and supplied to the transmission amplifier 25.

Furthermore, at the clock time t5, the voltage Vp sharply drops as represented by the graph 401 because, as a result of a sharp increase in the current, power stops being supplied from the power supply 11 and is replaced by power supplied from the power supply capacitor 101. Although the voltage of electricity output from the power supply capacitor 101 is boosted into the voltage Vb to be supplied, which slightly decreases when the transmission amplifier 25 operates. In this case, the voltage Vb is higher than the voltage Vp, so that the voltage VI coincides with the voltage Vb as represented by the graph 403. Here, the voltage Vp is lower than the minimum operating voltage represented by the line 502. However, the voltage Vb exceeding the minimum operating voltage is supplied to the transmission amplifier 25, which enables the transmission amplifier 25 to continue the operation thereof.

At the clock time t6 when a certain time starting from the clock time t5 elapses and when the power supply voltage output from the power supply 11 has increased, the voltage compensation circuit 10 is in a state illustrated in FIG. 10. In this case, the switch 104 is kept on. The switch 162 is kept off. The power supply voltage output from the power supply 11 has sufficiently increased, and therefore is supplied to the power supply capacitor 101 and the boost converter 102. The power supply voltage supplied to the power supply capacitor 101 is stored as electric charge in the power supply capacitor 101. The power supply voltage supplied to the boost converter 102 is boosted and then fed to the transmission amplifier 25 via the switch 104 and the diode 152.

At the clock time t6, as represented by the graphs 300 and 301 in FIG. 4, the base station device 1 is in the signal-transmitting state, and the transmitter 13 transmits some signal. As represented by the graph 302, input of the transmission/reception switching advance-notification signal to the timing controller 103 is continued. As represented by the graph 303, the switch 104 is kept on. As represented by the graph 304, the switch 162 is kept off. In addition, as represented by the graph 305, a boosted voltage is output from the diode 152 and supplied to the transmission amplifier 25.

Furthermore, at the clock time t6, the voltage Vp is gradually increasing as represented by the graph 401 because of voltage control performed thereon by the power supply 11. However, the power supply voltage is used for charging the power supply capacitor 101 and the operation of the transmission amplifier 25, and therefore increases at a slow pace. The voltage Vb is obtained by boosting the power supply voltage and then supplied, and therefore is maintained as a high voltage as represented by the graph 402. In this case, the voltage Vb is higher than the voltage Vp, so that the voltage VI coincides with the voltage Vb as represented by the graph 403.

At the clock time t7 when the period 207, or the boost-off standby time, starting from the clock time t3 that is when the switch 104 is turned on elapses, the timing controller 103 turns the switch 104 off. At the clock time t7, the voltage compensation circuit 10 is in a state illustrated in FIG. 11. That is, the switch 104 is turned off. The switch 162 is kept off. In this case, the power supply voltage output from the power supply 11 is not conveyed through the path on which the boost converter 102 is placed. In addition, electric charge is discharged from the capacitor 161 and supplied to the diode 152. The capacitor 161 has a potential obtained by boosting the power supply voltage, and has a higher potential than the power supply voltage. Consequently, a voltage output from the diode 152 is selected in the ORing circuit 105 to be supplied to the transmission amplifier 25. The power supply voltage output from the power supply 11 is not used for driving the transmission amplifier 25 but is all used for charging the power supply capacitor 101.

At the clock time t7, as represented by the graphs 300 and 301 in FIG. 4, the base station device 1 is in the signal-transmitting state, and the transmitter 13 transmits some signal. As represented by the graph 302, input of the transmission/reception switching advance-notification signal to the timing controller 103 is continued. As represented by the graph 303, the switch 104 is turned off. As represented by the graph 304, the switch 162 is kept off. In addition, as represented by the graph 305, electricity output from the diode 152 is supplied to the transmission amplifier 25.

Furthermore, at the clock time t7, the power supply voltage is all used for charging the power supply capacitor 101, and the voltage Vp therefore increases at a high rate as represented by the graph 401. While the potential of the capacitor 161 at the clock time t7 is the same as the potential obtained by boosting the power supply voltage, the voltage Vb is gradually decreasing as electric charge is discharged from the capacitor 161 to be supplied to the transmission amplifier 25. In this case, the voltage Vb is higher than the voltage Vp, so that the voltage VI coincides with the voltage Vb as represented by the graph 403.

Thus, the power supply voltage can be quickly restored to the standard voltage in a manner such that, while the power supply voltage output from the power supply 11 is all used for charging the power supply capacitor 101, electric charge stored in the capacitor 161 of the switching assist circuit 106 is used for driving the transmission amplifier 25. In this manner, the voltage compensation circuit 10 can quickly restore a state where the transmission amplifier 25 can be driven with the power supply voltage output by the power supply 11.

Power consumption is high when electricity the voltage of which has been boosted by the boost converter 102 is used for driving the transmission amplifier 25. For this reason, the transmission amplifier 25 starts being driven using the power supply voltage output from the power supply 11 as early as possible, so that power consumption can be lower.

The clock time t8 is a clock time when the advance-notification announcement period 210 starting from the clock time t2 that is when the transmission/reception switching advance-notification signal is input to the timing controller 103 elapses. That is, the clock time t8 is a clock time that is the assist-off standby time after the switch 104 is turned off. The clock time t8 coincides with the timing when the power supply voltage output from the power supply 11 is restored to the standard voltage. At the clock time t8, input of the transmission/reception switching advance-notification signal to the timing controller 103 is stopped. At this clock time, the timing controller 103 turns the switch 162 on. At the clock time t8, the voltage compensation circuit 10 is in a state illustrated in FIG. 12. That is, the switch 104 is of. The switch 162 is turned on. In this case, electricity is discharged from the capacitor 161 in a manner such that electric charge from the capacitor 161 is discharged through a path on which the resistor 163 is placed. In this case, the diode 152 does not output electricity. While not being conveyed through the path on which the boost converter 102 is placed, the power supply voltage output from the power supply 11 is supplied to the diode 151. Consequently, a voltage output from the diode 151 is selected in the ORing circuit 105, so that the power supply voltage is supplied as it is to the transmission amplifier 25.

At the clock time t8, as represented by the graphs 300 and 301 in FIG. 4, the base station device 1 is in the signal-transmitting state, and the transmitter 13 transmits some signal. As represented by the graph 302, input of the transmission/reception switching advance-notification signal to the timing controller 103 is stopped. As represented by the graph 303, the switch 104 is off. As represented by the graph 304, the switch 162 is turned on. In addition, as represented by the graph 305, electricity output from the diode 151 is supplied to the transmission amplifier 25.

Furthermore, at the clock time t8, the voltage Vp coincides with the standard voltage represented by the line 501. The voltage Vb sharply drops because electricity is discharged from the capacitor 161. In this case, the voltage Vp is higher than the voltage Vb, so that the voltage VI coincides with the voltage Vp as represented by the graph 403.

At the clock time t9 that is immediately after the elapse of the period 209, or the discharge-cancellation standby time, starting from the clock time t8 that is when the switch 162 is turned on, the timing controller 103 turns the switch 162 off. At the clock time t9, the voltage compensation circuit 10 is in a state illustrated in FIG. 13. That is, the switch 104 is of. The switch 162 is turned off. In this case, the power-supply voltage output from the power supply 11 is supplied as it is to the transmission amplifier 25 via the diode 151.

At the clock time t9, as represented by the graphs 300 and 301 in FIG. 4, the base station device 1 is in the signal-transmitting state, and the transmitter 13 transmits some signal. As represented by the graph 302, input of the transmission/reception switching advance-notification signal to the timing controller 103 is left stopped. As represented by the graph 303, the switch 104 is off. As represented by the graph 304, the switch 162 is turned off. In addition, as represented by the graph 305, electricity output from the diode 151 is supplied to the transmission amplifier 25.

Furthermore, at the clock time t8, the voltage Vp remains at the standard voltage represented by the line 501. Because discharge from the capacitor 161 is stopped, the voltage Vb maintains a potential due to electric charge remaining in the capacitor 161. In this case, a state where the voltage VI coincides with the voltage Vp is remained as represented by the graph 403.

Thereafter, at the clock time t10, as represented by the graphs 300 and 301 in FIG. 4, the base station device 1 transitions to the signal-receiving state, and the transmitter 13 stops transmitting any signal. The other statuses at the clock time t10 regarding signals and voltage remain in the same statuses as they have been in since the clock time t9.

In the case in which the voltage compensation circuit 10 according to this embodiment is not used, the power supply voltage output by the power supply 11 transitions as represented by the graph 601 in FIG. 4. A voltage represented by the graph 601 is supplied as it is to the transmission amplifier 25. In this case, as represented by the graph 601, the power supply voltage becomes lower than the minimum operating voltage represented by the line 502. Consequently, a voltage lower than the minimum operating voltage is supplied to the transmission amplifier 25, which possibly destabilizes the operation thereof. In addition, it takes a long time for the power supply voltage to recover to the standard voltage, and the operation of the transmission amplifier 25 continues to be unstable during the recovery.

Hereinafter, determination of the boost-on standby time, the boost-off standby time, and the assist-off standby time is described. The boost-on standby time, a period for which the switch 104 is on in the signal-receiving state, and a period for which the switch 104 is on in the signal-transmitting state are denoted by ΔTd, ΔTrxboost, and ΔTxboost, respectively. The assist-off standby time is denoted by ΔTwait. In this case, the boost-off standby time is expressed as

ΔTrxboost+ΔTxboost.

In addition, ΔTwait is expressed as

ΔTps−ΔTdis,

where: ΔTps denotes a time taken for the power supply voltage to recover to the standard voltage after the switch 104 is turned off; and ΔTdis denotes a time starting when the switch 162 is turned on and ending when the switch 162 is turned off.

The following conditions also hold:

ΔTps=Cps×(Vps−Vbooff)/Ilimit; and

ΔTdis=(Cas×(Vboost−Vps−Iload V×ΔTps))/((Idis+Iload)−Iload).

The following conditions also hold:

V1dlo=Vps−Iboostin−ΔTdps/Cps;

Vbooff=V1dlo+ΔTdps/Cps; and

Iboostin=Iload−Vboost/Vps.

Furthermore, the following conditions also hold:

V1up=(Ilimit−Iboostin)×ΔTviup/Cps; and

ΔTviup=ΔTtxboost−ΔTdps.

In the above expressions, Vps denotes a standard power supply voltage. Vbooff denotes a power supply voltage at turning off the switch 104. Ilimit denotes an overcurrent limit value for the power supply 11. Cas denotes the capacitance of the capacitor 161. Vboost denotes a voltage after boosting by the boost converter 102. Iload denotes a load current (load characteristic). Idis denotes a current from the capacitor 161 flowing when electric charge is discharged therefrom. V1dlo is a voltage at the end of power supply response delay after the start of signal transmission. Iboostin is a referred-to-input (RTI) for the boost converter 102 of Iload. ΔTdps denotes a response relay of the power supply 11 (power supply characteristic). Cps denotes the capacitance of the power supply capacitor 101. ΔV1up denotes an increase in voltage from when the power supply 11 starts response and until the switch 104 is turned off. ΔTviup denote a time starting when the response delay the power supply 11 ends and ending when the switch 104 is turned off.

Among the parameters used in the above expressions, Vps, Vboost, Cas, Idis, Iload, Ilimit, ΔTdps, Cps, and ΔTxboost are setting values, and preferably are set as requested.

The above-described setting values are set in the first place, and the boost-on standby time, the boost-off standby time, and the assist-off standby time are then calculated using the above expressions.

As described above, a voltage compensation circuit according to this embodiment boosts the voltage to be supplied to the transmission amplifier in advance of switch from the signal-receiving state to the signal-transmitting state in communication under the TDD scheme and supplies the electricity to a transmission amplifier. The voltage compensation circuit is thus enabled to supply a sufficiently high voltage to the transmission amplifier even when the power supply voltage has dropped as a result of an increase in the current by driving the transmission amplifier, thereby being able to keep the operation of the transmission amplifier stable, prevent degradation in ACLR, and prevent degradation in communication quality.

Another possible measure against decrease in the power supply voltage is to increase the capacitance of a power supply capacitor. This measure, however, inevitably increases the size of a circuit for the increased capacitance of the power supply capacitor. In addition, it is impossible to use a power supply capacitor having a capacitance exceeding the capacitance of the maximum load capacitance of a power supply, and it is therefore considered difficult to use a power supply capacitor having a capacitance large enough to avoid decrease in the power supply voltage. In contrast, the voltage compensation circuit according to this embodiment boosts the power supply voltage and stores therein energy, which makes it possible to add a capacitor having capacitance smaller than otherwise. Furthermore, the voltage compensation circuit according to this embodiment boosts a voltage in advance to be able to avoid occurrence of undershoot, and can prevent undershoot more effectively than that in the case where the power supply capacitor has an increased capacitance.

A possible approach to enabling a power supply voltage to recover after decreasing is to increase the current capacity of the power supply capacitor. This approach, however, makes it inevitable to use a large current capacity than needed for use, thus making it difficult to avoid volume increase of the power supply and cost increase. In some possible cases, a dedicated power supply needs to be built. In contrast, the voltage compensation circuit according to this embodiment temporarily disconnect a load current currently being fed and the power supply from each other, and uses all of power therefrom for charging the power supply capacitor, thereby enabling the power supply voltage to quickly recover with an appropriate current capacity.

### [b] Second Embodiment

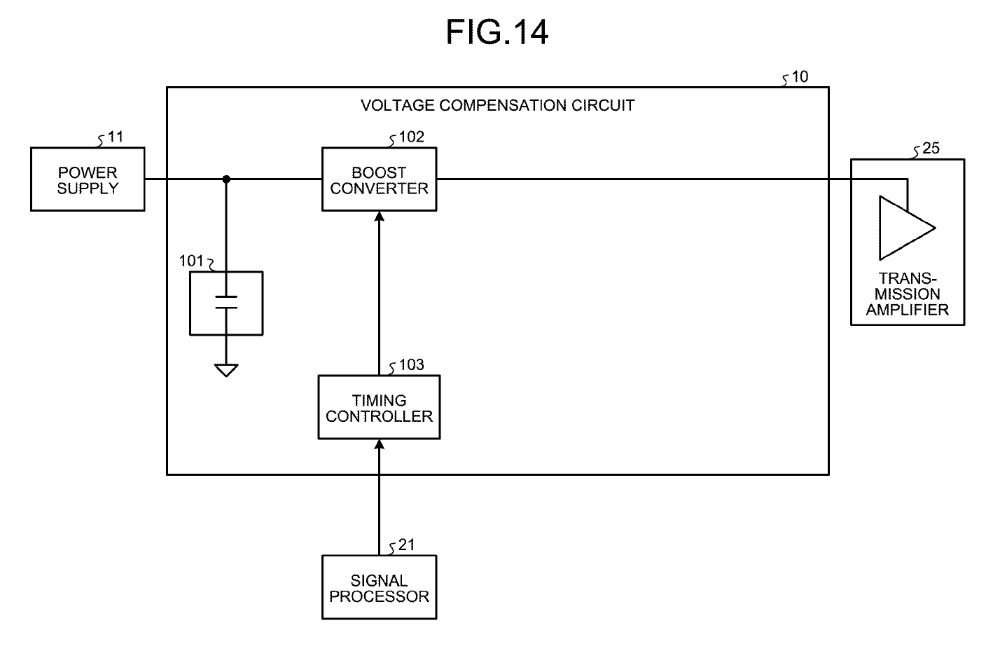

Next, a second embodiment is described. FIG. 14 is a block diagram of a voltage compensation circuit according to the second embodiment. The voltage compensation circuit according to this embodiment does not include the switching assist circuit 106, which is the difference thereof from the one according to the first embodiment.

The timing controller 103 receives input of the transmission/reception switching advance-notification signal from the signal processor 21 a certain period before the start of signal transmission. The timing controller 103 then starts the operation of the boost converter 102 after the elapse of the boost-on standby time that starts when the transmission/reception switching advance-notification signal is received. Thereafter, at the right time after the power supply voltage output from the power supply 11 recovers to the standard voltage, input of the transmission/reception switching advance-notification signal from the signal processor 21 to the timing controller 103 is stopped. The timing controller 103 stops the operation of the boost converter 102 when input of the transmission/reception switching advance-notification signal is stopped.

While not operating, the boost converter 102 supplies the power supply voltage output from the power supply 11 to the transmission amplifier 25. While operating, the boost converter 102 boosts voltage supplied from the power supply 11 or the power supply capacitor 101, and supplies the boosted voltage to the transmission amplifier 25.

With the transmission amplifier 25 operating after signal transmission is started, the current increases, and the power supply 11 stops the output as a result. In response, the power supply capacitor 101 discharges electric charge stored therein, thereby supplying electricity to the boost converter 102. Thereafter, when the power supply voltage output from the power supply 11 increases to a high voltage, the power supply capacitor 101 is charged with the power supply voltage.

The following description sums up a sequence of procedure steps of voltage compensation that the voltage compensation circuit 10 according to this embodiment performs. The operation of the boost converter 102 is started after the elapse of the boost-on standby time that starts when the transmission/reception switching advance-notification signal is received. Thereafter, the transmission amplifier 25 receives input of a boosted voltage.

After signal transmission is started subsequently, the current increases, the output from the power supply 11 is therefore stopped, and electricity output from the power supply capacitor 101 is supplied to the transmission amplifier 25 after the voltage thereof is boosted by the boost converter 102. Thus, even when the current increases after signal transmission is started, the transmission amplifier 25 can receives supply of sufficiently high voltage.

Thereafter, when the power supply voltage increases to be sufficiently high, the power supply voltage output from the power supply 11 is supplied to the boost converter 102 and the power supply capacitor 101. Electricity supplied to the boost converter 102 is boosted and then supplied to the transmission amplifier 25. Electricity supplied to the power supply capacitor 101 is used for charging the power supply capacitor 101. At this point in time, the power supply voltage output from the power supply 11 is still yet to reach the standard voltage but is boosted by the boost converter 102, so that the transmission amplifier 25 can receive supply of sufficiently high voltage.

Thereafter, the power supply voltage output by the power supply 11 recovers to the standard voltage, and the operation of the boost converter 102 is then stopped. A state where the power supply voltage output from the power supply 11 is supplied as it is to the transmission amplifier 25 is restored.

As described above, the voltage compensation circuit according to this embodiment boosts the power supply voltage and supplies the thus boosted voltage to the transmission amplifier before the start of signal transmission. Thereafter, after the power supply voltage recovers to the standard voltage, the voltage compensation circuit cancels the boosting and supplies the power supply voltage as it is to the transmission amplifier. Thus, regardless of whether the voltage has decreased as a result of current increase due to the start of transmission, sufficiently high voltage can be supplied to the transmission amplifier, thereby being able to keep the operation of the transmission amplifier stable, prevent degradation in ACLR, and prevent degradation in communication quality.

An aspect of a voltage compensation circuit, a wireless communication device, and a voltage compensation method disclosed in the present application brings about the effect of preventing deterioration of communication quality.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A voltage compensation circuit in a wireless communication device that performs wireless communication under a time division duplex (TDD) scheme, the voltage compensation circuit comprising:
a first path that supplies power output from a power supply and having a first voltage;
a second path that supplies power having a second voltage obtained by boosting the first voltage of the power output from the power supply; and
a switching unit that switches the paths between the first path and the second path based on information on timing of switch from signal reception to signal transmission.

2. The voltage compensation circuit according to claim 1, wherein the switching unit
switches the paths to the second path a certain period before the timing of switch to signal transmission and
switches to the first path after the wireless communication device has started transmitting a signal and after a power-supply voltage output from the power supply has recovered to a certain voltage.

3. The voltage compensation circuit according to claim 1, further comprising a capacitor that serves as a substitute for the power supply and outputs power when a voltage from the power supply has dropped.

4. The voltage compensation circuit according to claim 3, further comprising a switching assist circuit that stores therein electric charge having a certain voltage, wherein
the switching unit blocks the power supply from the second path, and
the switching assist circuit supplies power via a part of the second path while the capacitor is being charged with power output from the power supply.

5. A wireless communication device comprising:
a power supply that outputs power having a first voltage;
a transmitter that transmits signals;
a first path that supplies, to the transmitter, power output from the power supply and having the first voltage;
a second path that supplies power having a second voltage obtained by boosting the first voltage of the power output from the power supply; and
a switching unit that switches the paths between the first path and the second path based on information on timing of switch from signal reception to signal transmission.

6. A voltage compensation method in a wireless communication device that performs wireless communication under a TDD scheme, the voltage compensation method comprising:
acquiring information on timing of switch from signal reception to signal transmission; and
based on the acquired information, switching paths between a first path that supplies power output from the power supply and having the first voltage and a second path that supplies power having a second voltage obtained by boosting the first voltage of the power output from the power supply.
